(19) United States
(12) Patent Application Publication
(10) Pub. No.: US 2015/0321439 A1
(43) Pub. Date: Nov. 12, 2015

(54) Paper Bag and Method for Producing a Paper Bag

(71) Applicant: Mondi AG, Wien (AT)

(72) Inventors: Uwe Vogelskamp, Karlstadt (DE); Hans-Joachim Wichmann, Sendenhorst (DE)

(21) Appl. No.: 14/705,488

(22) Filed: May 6, 2015

(30) Foreign Application Priority Data
May 8, 2014 (DE) 10 2014 006 815.3

(51) Int. Cl. B31F 1/07; B65D 30/00; B65D 33/00

(52) U.S. Cl. CPC B31F 1/07; B65D 33/004; B65D 31/00; B31F 2201/0758; B31F 2201/0715

(57) ABSTRACT

In the case of a paper bag having a bag wall (1), which separates an inner bag space from an outer space and has at least one visible side (1a) visible from the outer space and an invisible inner side (1b) of a paper layer which is provided with an embossment (9) in the form of at least one symbol, good visibility of the embossment (9) is combined with gentle treatment of the paper fibers of the paper layer by virtue of the fact that the embossment (9) the embossment (9) is embodied in the form of a surface (10) which is elevated with respect to a plane (12) adjacent to the embossment (9) on the visible side (1a) and, corresponding thereto, as a depression which is present with respect to a plane of the inner side adjacent to the embossment (9) on the inner side (1b), that the elevated surface (10) on the visible side (1a) is connected to the plane (12) of the visible side (1a) by means of a connecting wall (11), and that the transition of the elevated surface (10) to the connecting wall (11) and the transition of the connecting wall (11) to the plane (12) of the visible side (1a) have a rounded form, and that the thickness of the paper layer in the region of the embossment (9) is at most 20% smaller than the thickness of the paper layer in the plane (12) adjacent to the embossment (9). An embossment (9) of this type is preferably produced by virtue of the fact that the embossment (9) is formed by guiding the bag wall (1) between an embossing tool (1) and a pressure-exerting tool (3) provided with an elastically compliant surface (5), the embossing tool (2) having the at least one symbol (4) in a depressed formation, such that the paper layer is pressed into the symbol (4) of the embossing tool (1) into the pressure-exerting tool (3) during the embossing operation.

### FIELD OF THE INVENTION

The invention relates to a paper bag in the form of a bag closed at least on one side with a folded base, said paper bag being designed for a filling material load of 5 kg and more and being provided with a bag wall, which separates an inner bag space from an outer space and has at least one visible side visible from the outer space and an invisible inner side of a paper layer which is formed from at least one layer of bag kraft paper and is provided with an embossment in the form of at least one symbol.

### BACKGROUND

It is known to provide bags or pouches with a marking during the production operation in order to make it possible for desired information to be read by an operator or automatically. On account of disadvantages which are associated with the printing-on of information, it is known to introduce information of this nature into the bag wall through an embossment.

EP 2 347 968 B1 accordingly describes a plastic bag, into which a relief is embossed with an embossing mechanism consisting of a die and a punch. While this embossment can be introduced without problems in the case of a plastics wall on account of the toughness of the plastics material, embossing of this nature experiences problems in the case of bag walls made of paper. Conventional paper grades are not so bendable that an embossment can be realized with a die and a corresponding punch without causing considerable damage to or at least weakening the paper layers. When the paper bag is being filled with considerable weights, weakening of the paper layers can lead to breakage of the paper wall and therefore render the bag unusable.

It is therefore known from DE 1 176 548 to introduce embossed marks into a paper bag wall by inserting the bag wall between an embossing punch and a hard, flat substrate, such that the embossing merely compresses the paper material in the region of the symbols, and therefore the symbols appear as a depression on the visible side. An embossment of this type is not readily identifiable and also is not permanent, since on the one hand it is partially removed again by minor restoring forces in the paper material and on the other hand can also disappear as a result of external influences, for example by swelling of the paper material under the effect of moisture.

### SUMMARY

The present invention is therefore based on the problem of marking a paper bag with an embossment in such a way that on the one hand the embossment is readily identifiable and on the other hand the embossed paper layer is not torn or at least considerably weakened by the embossment.

To achieve this object, a paper bag of the type mentioned in the introduction is characterized in that, according to the invention, the embossment is embodied in the form of a surface which is elevated with respect to a plane adjacent to the embossment on the visible side and, corresponding thereto, as a depression which is present with respect to a plane of the inner side adjacent to the embossment on the inner side, in that the elevated surface on the visible side is connected to the plane of the visible side by means of a connecting wall, and in that the transition of the elevated surface to the connecting wall and the transition of the connecting wall to the plane of the visible side have a rounded form, and in that the thickness of the paper layer in the region of the embossment is at most 20% smaller than the thickness of the paper layer in the plane adjacent to the embossment.

The paper bag according to the invention therefore has an embossment, which, in the manner of a thermoforming operation, leads to an elevated surface on the visible side and to a corresponding depression on the inner side, such that the embossment appears as at least one symbol in a form raised on the visible side. In the process, the thickness in the region of the embossment remains virtually unchanged and is at most 20%, preferably at most 10%, smaller than the thickness of the paper layer in the plane adjacent to the embossment. The embossing therefore leads to a realignment of the paper layer by approximately an extent which corresponds to the order of magnitude of the thickness of the paper layer. The paper layer of the bag wall preferably consists of bag kraft paper, this being embodied in particular as semi-extensible bag kraft paper. To preserve the paper layer and to afford protection against breakage, the transitions from the connecting wall to the plane of the visible side and to the elevated surface of the embossment have a rounded rather than a sharp-edged form, as a result of which the paper fibers are not subject to buckling, but instead the paper layer is merely extended.

The design according to the invention therefore makes it possible for the first time to perform embossing in a bag wall of a paper bag which does not involve compression of the paper layer in the region of the embossment. On the one hand, this achieves good identifiability of the embossment, but on the other hand excessive loading of the at least one paper layer of the bag wall is avoided. In a preferred embodiment, the transition of the elevated surface to the connecting wall has a transition radius of >0.3 mm. The rounded transition of the connecting wall to the plane of the visible side is formed with a transition radius of at least 0.1 mm. In this respect, it may be expedient if the connecting wall does not form a right angle with the plane of the visible side alongside the embossment, but instead an obtuse angle of between 91° and 120°, in particular of between 91° and 110° and furthermore in particular between 92° and 100°.

A paper bag according to the invention is preferably a bag which is closed at least on one side with a folded base and which can withstand relatively large filling material masses (5 kg and more). A paper bag of this type can have a multi-layer configuration and in particular can have a plurality of paper layers.

However, a paper bag for the purposes of the present invention can also be present if the paper layer forms a bag of which the wall has only the one paper layer and is intended for smaller weights.

With the present invention, it is furthermore not excluded that the visible side of the paper layer is covered with a transparent plastics layer, as a result of which a certain resistance to the effects of moisture and contamination is ensured.

The paper bag according to the invention can preferably be produced by virtue of the fact that the embossment is formed by guiding the bag wall between an embossing tool and a pressure-exerting tool provided with an elastically compliant surface, the embossing tool having the at least one symbol in a depressed formation, such that the paper layer is pressed into the depression of the embossing tool by the pressure-exerting tool during the embossing operation.

As a result of the paper layer being pressed into the depression of the embossing tool by means of the elastically compliant surface of the pressure-exerting tool, it is ensured that the forces exerted on the paper layer remain limited as the latter is pressed into the depression of the embossing tool which represents the symbol, and the paper fibers are not broken.

The embossing can be integrated advantageously in the operation for manufacturing the paper bag if the embossing tool used is an embossing roll and the pressure-exerting tool used is a pressure-exerting roll. The embossment can then already be introduced into the material of the bag wall before said material is customarily closed to form a tube by means of a longitudinal seam.

It goes without saying that it is also possible, however, to introduce the embossment according to the invention at a later production stage or else into the finished bag.

The pressure-exerting roll is preferably an elastic silicone roll having a hardness of approximately 50 Shore A, i.e. between 45 and 55 Shore A.

### DESCRIPTION OF THE DRAWINGS

The invention will be explained in more detail hereinbelow on the basis of an exemplary embodiment shown in the drawing, in which:

FIG. 1 shows a schematic illustration of an embossing tool in the form of an embossing roll and of a pressure-exerting tool in the form of a pressure-exerting roll, between which the material of the bag wall is guided;

FIG. 2 shows an enlarged illustration of the contact between the embossing roll, the material of the bag wall and the pressure-exerting roll during embossing.

### DETAILED DESCRIPTION

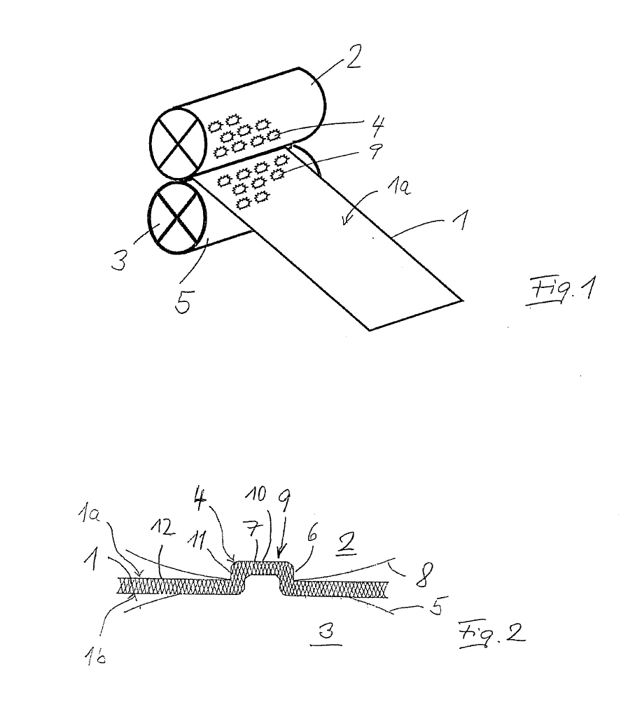

FIG. 1 shows that, to produce an embossment in the material of a bag wall 1, said bag wall is guided, for example laid flat before the formation of a bag tube, between an embossing roll 2 and a pressure-exerting roll 3. For the sake of simplicity, the material of the bag wall 1 is shown with a single paper layer, which points with a visible side 1a toward the embossing roll and with an inner side 1b toward the pressure-exerting roll 3. The embossing roll 2 has at least one embossing symbol 4 as a depressed relief which is worked into the cylindrical surface. The pressure-exerting roll 3 is coated with an elastically compliant surface 5 made of a silicone elastomer having a hardness of 50 Shore A and has a cylindrical initial shape. In their operating position, the embossing roll and the pressure-exerting roll 3 are positioned in relation to one another in such a way that the elastically compliant surface 5 is pressed in by the surface of the embossing roll 2 in a contact region to such an extent that, when the embossing symbol 4 is in the contact region, the bag wall 1 is pressed into the depression by the elastic restoring force of the pressure-exerting roll 3. This shapes the bag wall 1 in the manner shown in enlarged form in FIG. 2. The embossing symbol 4 is as a depression with side walls 6 and a deep base surface 7, which runs substantially parallel to a surface 8 of the embossing roll 2 outside the embossing symbol 4. The bag wall 1 is pressed into the depression which represents the embossing symbol 4 by the elastically compliant surface 5 of the pressure-exerting roll. This gives rise to a profile of the bag wall 1 as is shown in FIG. 2. The embossment 9 formed in the bag wall 1 consists of an elevated surface 10, which is delimited by a connecting wall 11. The connecting wall 11 merges into a plane 12 outside the embossing symbol 9.

The transition between the elevated surface 10 and the connecting wall 11 is made with a transition radius which is greater than 0.3 mm. The transition between the connecting wall 11 and the plane 12 of the visible side 1a of the bag wall 1 likewise has a rounded form, the transition radius r2 being at least 1 mm. The connecting wall 11 can form a right angle with the plane 12—as is shown schematically. It may also be advantageous, however, if the connecting wall 11 forms an obtuse angle, an angle which is therefore greater than 90°, with the plane 12. For reasons of expediency, the obtuse angle should not be greater than 120°.

The embossment 9 is formed in the bag wall 1 by virtue of the fact that the elastically compliant surface 5 of the pressure-exerting roll 3 presses the material of the bag wall 1 into the depression which forms the symbol 4, the formation of sharp-edged corners being avoided. Since the exertion of pressure is performed by the elasticity of the surface 5 of the pressure-exerting roll 3, the pressing force is limited and does not lead to compression of the paper layer of the bag wall 1. A reduction in the thickness of the bag wall 1 is obtained exclusively by virtue of the fact that the paper layer is extended as it is being pressed into the depression of the embossing symbol.

For a readily legible embossment, it is expedient if the depth of the embossment 9 corresponds approximately to the thickness of the bag wall 1, i.e. lies in the range of 200 to 300 μm. The extension of the paper layer of the bag wall which is caused thereby is small and leads to a reduction in the thickness of the bag wall of less than 20%, preferably of less than 10%.

1. Paper bag in the form of a bag closed at least on one side with a folded base, said paper bag being designed for a filling material load of 5 kg and more and being provided with a bag wall (1), which separates an inner bag space from an outer space and has at least one visible side (1a) visible from the outer space and an invisible inner side (1b) of a paper layer which is formed from at least one layer of bag kraft paper and is provided with an embossment (9) in the form of at least one symbol, wherein the embossment (9) is embodied in the form of a surface (10) which is elevated with respect to a plane (12) adjacent to the embossment (9) on the visible side (1a) and, corresponding thereto, as a depression which is present with respect to a plane of the inner side adjacent to the embossment (9) on the inner side (1b), in that the elevated surface (10) on the visible side (1a) is connected to the plane (12) of the visible side (1a) by means of a connecting wall (11), and in that the transition of the elevated surface (10) to the connecting wall (11) and the transition of the connecting wall (11) to the plane (12) of the visible side (1a) have a rounded form, and in that the thickness of the paper layer in the region of the embossment (9) is at most 20% smaller than the thickness of the paper layer in the plane (12) adjacent to the embossment (9).

2. Paper bag according to claim 1, wherein the transition of the elevated surface (10) to the connecting wall (11) has a transition radius of ≧0.3 mm.

3. Paper bag according to claim 1, wherein the rounded transition of the connecting wall (11) to the plane (12) of the visible side (1a) has a transition radius (r2) of >0.1 mm.

4. Paper bag according to claim 1, wherein the connecting wall (11) forms an angle of 90° with the elevated surface (10).

5. Paper bag according to claim 1, wherein the connecting wall (11) forms an obtuse angle of between 91° and 120° with the elevated surface (10).

6. Paper bag according to claim 1, wherein the bag wall (1) has a multi-layer configuration.

7. Paper bag according to claim 6, wherein the bag wall (1) has a plurality of paper layers.

8. Paper bag according to claim 1, wherein the visible side (1a) of the paper layer is covered with a transparent plastics layer.

9. Method for producing a paper bag according claim 1, wherein the embossment (9) is formed by guiding the bag wall (1) between an embossing tool (1) and a pressure-exerting tool (3) provided with an elastically compliant surface (5), the embossing tool (2) having the at least one symbol (4) in a depressed formation, such that the paper layer is pressed into the symbol (4) of the embossing tool (1) by the pressure-exerting tool (3) during the embossing operation.

10. Method according to claim 9, wherein the embossing tool used is an embossing roll and the pressure-exerting tool used is a pressure-exerting roll.
